(19) United States
(12) Patent Application Publication
(10) Pub. No.: US 2006/0213898 A1
(43) Pub. Date: Sep. 28, 2006

(54) Oven door locking and lighting assembly

(75) Inventor: Richard Beaudoin, Drummondville (CA)

Correspondence Address: MERCHANT & GOULD PC, P.O. BOX 2903, MINNEAPOLIS, MN, 55402-0903, US

(73) Assignee: LOGIMEX INC., Drummondville (CA)

(21) Appl. No.: 11/365,771

(22) Filed: Feb. 28, 2006

Related U.S. Application Data
(60) Provisional application No. 60/656,379, filed on Feb. 28, 2005.

(51) Int. Cl. A21B 1/00; A21B 1/22; F27D 11/00

(52) U.S. Cl. 219/413

(57) ABSTRACT

The invention concerns an automatic oven door locking assembly for locking an oven door. The locking assembly includes a mounting plate, a switch and a latch plate. The latch plate has a hook engageable with an anchor in the oven door, and is moveable between positions where the hook disengages or engages the anchor. The assembly also includes a cam that is rotatably driven by a drive shaft and operatively connected to the latch plate so that when the cam rotates the latch plate moves from one position to another. The cam has an eccentric extension that engages and disengages the switch when the cam rotates. The assembly further includes biasing means to urge the movement of the latch plate from one position to another so that a portion of the latch plate disengages or engages the switch.

### FIELD OF THE INVENTION

This invention generally relates to the field of oven door locking assemblies, and more specifically to assemblies for automatically locking an oven door for self-cleaning and for indicating the door's position with a light indicator.

### BACKGROUND OF THE INVENTION

Oven door locking assemblies are important components in ovens, especially when the oven is performing an operation such as self-cleaning.

Self-cleaning ovens attain temperatures in the range of 900° F. (482° C.) during the cleaning cycle to burn off spills left over from cooking. A typical cleaning cycle can last three hours. A self-cleaning oven is designed with a mechanical interlock to insure that the oven door remains closed during and soon after the self-cleaning cycle. These locking mechanisms can be manual or automatic.

Oven door locking mechanisms act as safeguards for protecting users from burn injuries. If the door were to be opened during the self-cleaning cycle, the intense heat would rush out and could cause severe burns. This objective is often achieved by an automatic system, which incorporates a processor with circuitry and programming as well as sensors that insure that the oven temperature will not rise above a certain level unless the locking mechanism engages the closed oven door. Once the oven door is latched, the processor will not allow the door to be reopened unless the oven temperature decreases below a certain level either because the self-cleaning operation was aborted or completed.

Automatic oven door mechanisms are advantageously provided with means for sending signals. The processor in an automated oven processes signals for initiation of oven self-cleaning, timed cooking, temperature monitoring and activating other indicators such as lights and alarms.

In the prior art, separate mechanisms have been used to send signals to the processor to, for example, indicate that the locking mechanism has locked the oven door and indicate that the oven door is open. Thus oven doors have traditionally been provided with two switches: one for indicating that the door is locked and another for indicating that the door is open. A locking assembly would be provided with a switch to indicate when the oven door is locked. When the door is closed, the switch is engaged, for example. Separately installed on another part of the oven would be a light switch. The light switch would send a signal to turn on a light when the oven door was open.

Automatic locking mechanisms may use a cam mounted on a rotating shaft, the cam simultaneously used to produce a locking motion of a latch and to engage a switch to start oven cleaning and/or indicate that the door is locked. The switch sends a signal to a central processor, usually an automaton, which then initiates oven cleaning. Thus the switch incorporated into the locking assembly sends a signal for indicating whether the door is locked or not.

Light indicators have traditionally functioned separately from lock mechanisms in oven doors. Thus the light indicator switches have had to be installed separately, that is, in addition to lock assemblies. Opening the oven door causes a light switch to be engaged or disengaged and thus causes a light indicator to turn on, confirming that the door is open. Likewise, when the door is closed, the switch is engaged or disengaged to confirm that the door is closed.

In the prior art, oven door locking mechanisms that employ a plurality of switches for various functions can be found. The U.S. Pat. No. 6,601,882 (COLE), Canadian patent No. 1,326,504 (FOX) and Japanese patent JP 5,203,162 show locking mechanisms that can engage a plurality of switches for controlling several functions of the oven.

On the other hand, the U.S. Pat. No. 6,315,336 (SWARTZELL) describes a locking mechanism including a cam, a latch plate and at least one switch. The cam and latch plate can each engage a switch for sending two signals, however, the cam and latch plate do not engage a same switch alternatively for managing oven functions.

An oven locking mechanism according to the prior art is also shown in FIGS. 1a and 1b. This mechanism shows how a switch may be engaged by a rotating cam. FIG. 1a shows the cam engaging the switch and FIG. 1b shows the cam disengaging the switch after rotating. The switch is thus engaged one time per rotation of the cam.

On a large scale, the assembly and installation costs of two separate switches for two functions are significant. The labour to install the light switches and also the raw material of the light switches result in greater material demands and man-hour costs. Incorporating the functions of sending a signal for indicating that the door is locked and sending a signal for indicating that the door is open via one switch, would reduce assembly and installation costs because one switch would accomplish both functions.

### SUMMARY OF THE INVENTION

An object of the present invention is to provide an automatic oven door locking and lighting assembly that satisfies the above mentioned need.

Accordingly, the present invention comprises an automatic oven door locking assembly suitable for use with an oven door of an automatic oven. The assembly includes a mounting plate to mount the locking assembly within the oven and a switch with an on position and an off position mounted to the mounting plate to respectively send an on signal and an off signal to an oven processor. The assembly also includes a latch plate operatively mounted to the mounting plate, the latch plate having a hook engageable with an anchor point within the oven to lock the oven door. The latch plate is moveable between a first position where the hook disengages the anchor point and a second position where the hook engages the anchor point. The latch plate is also movable between said first position and a third position where a portion of the latch plate engages the switch and turns the switch to said on position. The assembly further includes a cam mounted to a drive shaft and rotatably driven thereby, the cam being operatively connected to the latch plate so that when the cam rotates the latch plate moves between said first and second position. The cam has at least one eccentric extension that alternately engages and disengages the switch when the cam rotates, thereby alternately turning the switch to the on and off position. The assembly also includes biasing means operatively connected to the latch plate to urge the movement of the latch plate from the first position to the third position when the oven door is open, the latch plate being brought back to the first position upon closing the oven door.

According to a preferred aspect of the assembly, the latch plate is provided with at least one guide slot along which the latch plate slides to the first, second and third positions. The latch plate is preferably provided with restraints between which the cam sits and on which the cam pushes when rotating to translationally slide the latch plate in and out of the second position.

The biasing means preferably comprise a torsion spring including a coil and having first and second ends extending from the coil and which are connected to the mounting plate and the latch plate respectively. The torsion spring advantageously has a substantially 60° angle between its first and second ends when the spring is in a relaxed state.

The switch preferably sends alternate signals to the processor which is programmed to perform actions such as sending an OK signal to enable a self-cleaning operation of the oven when the latch is in the closed position, and the switch is in said off position; turning off a light when the switch is in said off position; upon receiving a signal from a self-cleaning actuator, actuating the motor provided that said OK signal has been sent; and upon receiving said on signal from the switch, either stopping the motor provided that said signal from the self-cleaning actuator has been sent and the motor is in motion, or activating the light within the oven.

According to a preferred embodiment of the assembly, the cam is provided with more than one eccentric extension, or more than one projection or notch, for successively engaging and turning the switch on and then disengaging and turning the switch off, when the cam is rotated from one position to another. In this case, the switch preferably sends a signal to the processor for an additional function such as pre-heating, airing, lighting, cooling or another oven function, each time one of the eccentric extensions engages the switch.

It is also preferable that the components of the assembly be made of heat resistant material such as stainless steel.

### BRIEF DESCRIPTION OF THE DRAWINGS

The advantages of the invention will become more apparent upon reading the detailed description, referring to the drawings in which:

FIGS. 1a and 1b are side views of a prior art oven door locking mechanism. The latch plate is shown in an opened position in FIG. 1a and a locked position in FIG. 1b.

FIGS. 2a to 2c are side views of a preferred embodiment of the present invention. The latch plate is in an opened position (also called the “third position”) in FIG. 2a, a closed position (also called the “first position”) in FIG. 2b and a locked position (also called the “second position”) in FIG. 2c.

FIGS. 3a to 3d are side views of another preferred embodiment of the present invention. The latch plate is in an opened position (also called the “third position”) in FIG. 3a, a closed position (also called the “first position”) in FIG. 3b, a locked position (also called the “second position”) with switch on in FIG. 3c, and a locked position with switch off in FIG. 3d.

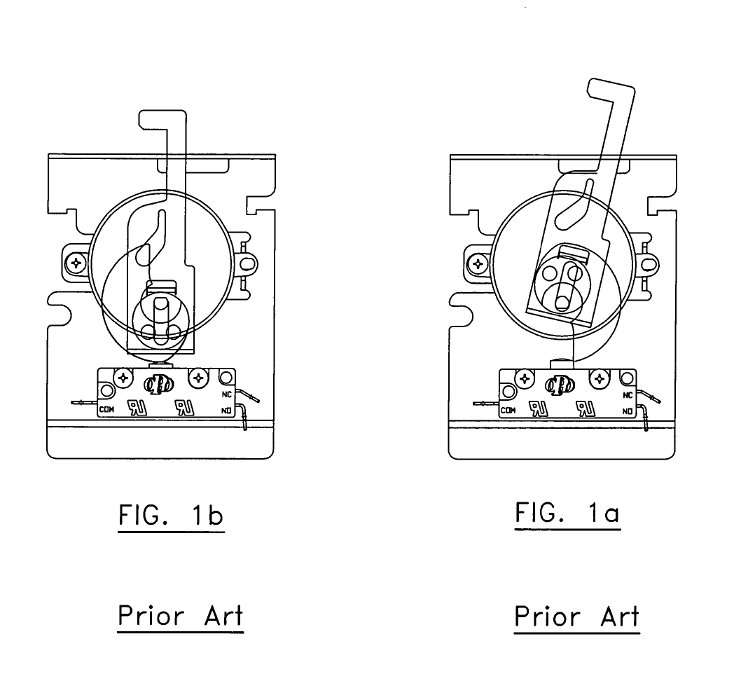

While the invention will be described in conjunction with example embodiments, it will be understood that it is not intended to limit the scope of the invention to such embodiments. On the contrary, it is intended to cover all alternatives, modifications and equivalents as may be included as defined by the appended claims.

### DESCRIPTION OF PREFERRED EMBODIMENTS

In the following description, similar features in the drawings have been given similar reference numerals.

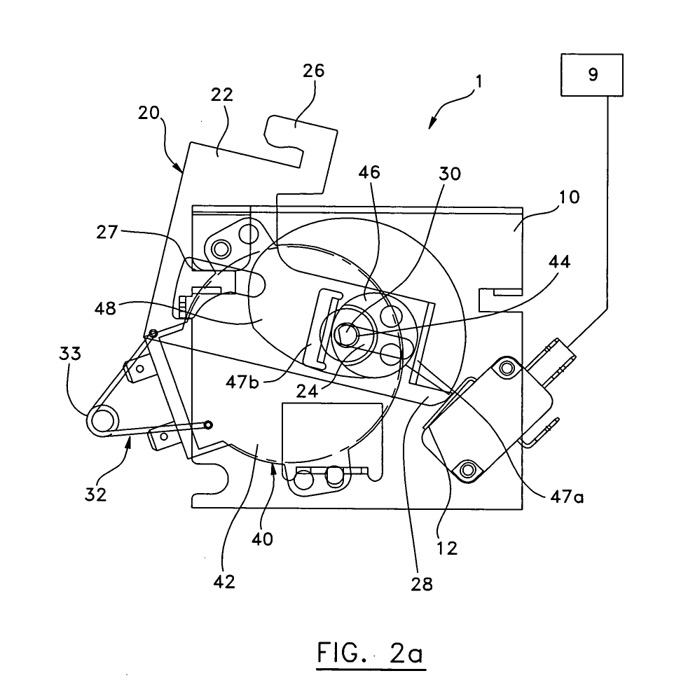

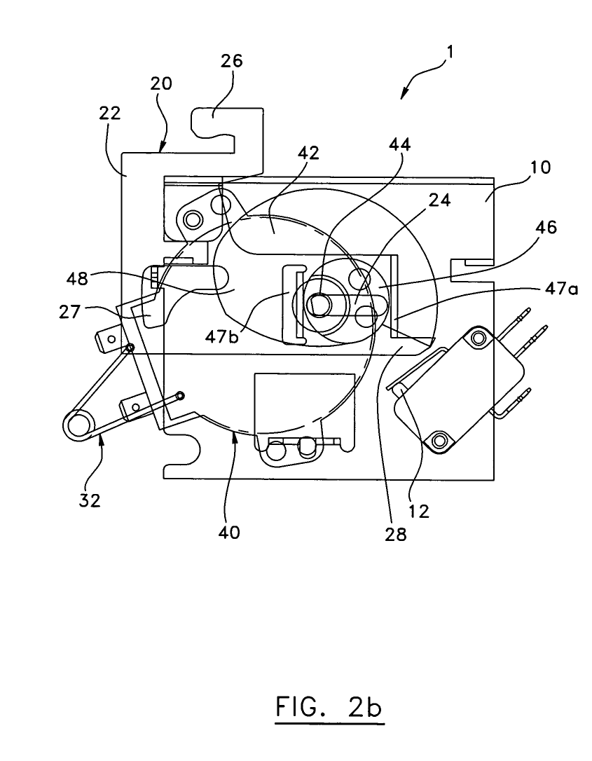

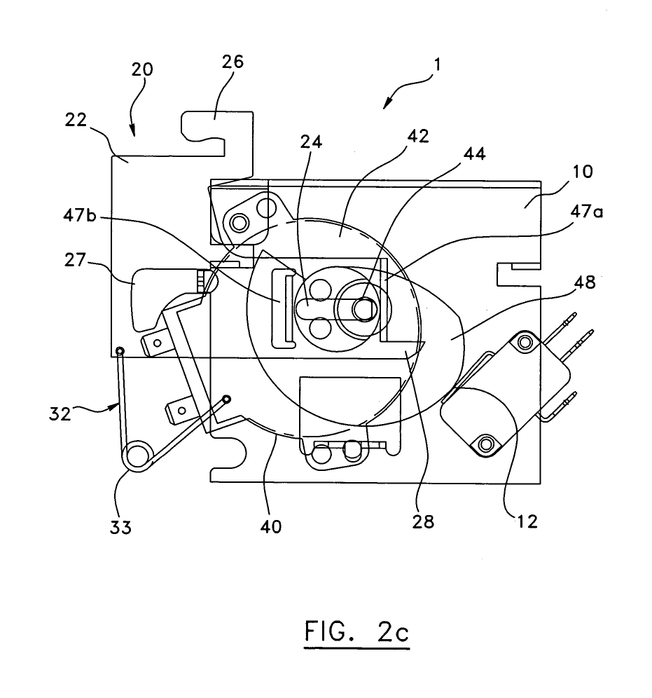

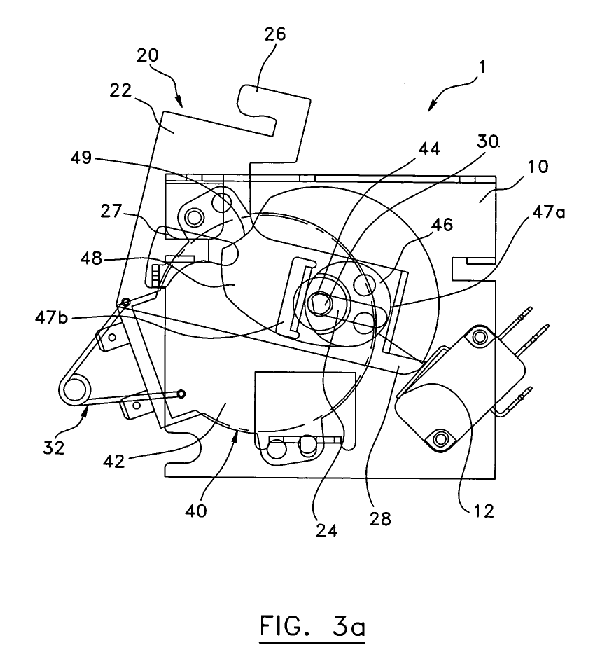

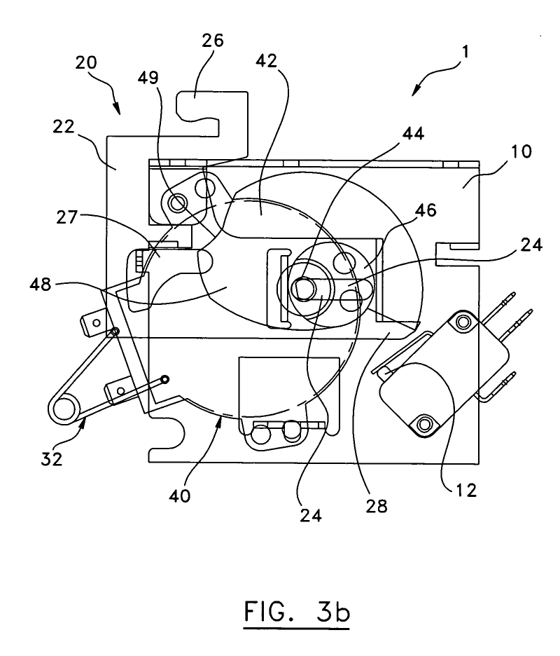

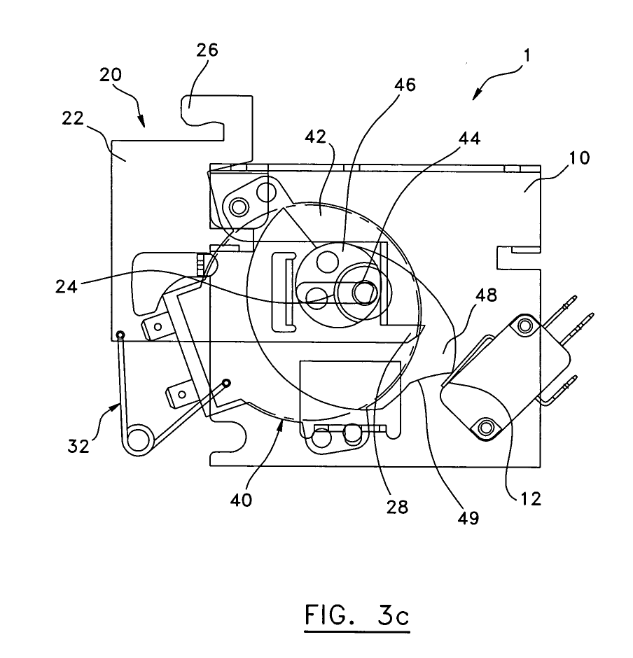

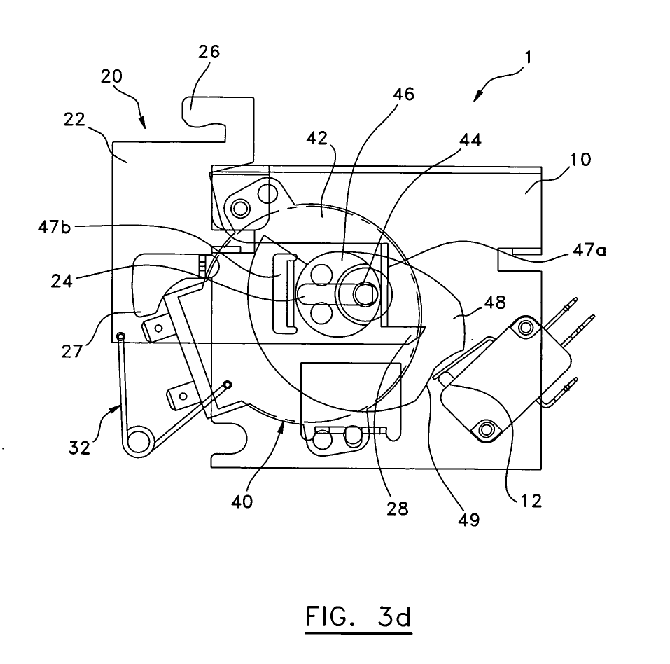

Referring to FIGS. 2a, 2b and 2c or 3a, 3b, 3c and 3d the present invention comprises an automatic oven door locking assembly (1) suitable for use with an automatic oven, comprising a processor (9) (shown in FIG. 2a) adapted to receive and send signals to actuate electric components of the oven. The oven door locking assembly (1) comprises a mounting plate (10) to mount the locking assembly (1) within the oven. A switch (12), preferably with an on position and an off position, is mounted to the mounting plate (10), the switch (12) being connectable to the processor of the oven for sending an on or an off signal to the processor. The switch may also have more than two positions, various engaging elements urging it to various different positions (i.e. the switch is not necessarily a digital/binary device).

FIGS. 2a and 2c show the switch (12) being engaged and thus in the on position. A latch plate (20) is mounted to the mounting plate (10) adjacent to the switch (12), the latch plate (20) comprising a plate body (22) preferably provided with a guiding slot (24), a first end (26) provided with a hook, and a second end (28) opposite the first end. The second end (28) may also comprise a projection, as shown in FIG. 2a.

The latch plate (20) is preferably movable in rotation about a pivot axis (30) extending within said guiding slot (24), between a first position where the second end (28) disengages and turns the switch (12) to said off position, as in FIG. 2b, and a third position where the second end (28) engages and turns the switch (12) to said on position, as in FIG. 2a. The first position, shown in FIG. 2b, is also referred to as the closed or unlocked position, while the third position is also referred to as the open position. When the latch plate (20) is in the closed position, it is also movable in translation with respect to the pivot axis (30) between the closed position and a second position, as in FIG. 2c, where the latch plate (20) moves away from the switch (12) for the first end (26) to engage an anchor point within the oven allowing the oven door to be locked. Thus, the second position is also referred to as the locked position. This locking movement is largely translational, but also depends on the guiding and biasing mechanisms that may be in place. Guiding slots (24, 27) and supplementary guiding slots are preferably provided in the latch plate (20) itself; but guiding slots may additionally or alternatively be provided in the mounting plate. Other guiding means may also be used for guiding the latch plate (20) to the different positions.

It is important to realise that the open position, closed position and locked position each designate a range of positions of the moving elements of the assembly. For example, the latch plate (20) hook must first engage the anchorage point in the oven before it fully locks into place in the locked position. Thus the “locked position” of the latch plate includes the first engagement of the hook and the anchorage point as well as the subsequent full engagement of the two elements. Likewise, the latch plate (20) and cam (46) can have a range of precise orientations in the closed position, in which the hook is disengaged from the anchorage point.

Biasing means (32) are provided for urging the latch plate (20) in the open position when the latch plate (20) is in the unlocked position, the latch plate (20) being brought back to the closed position upon closing the door of the oven. Thus the biasing means (32) open the latch plate (20) when the oven door is open. The biasing means (32) are advantageously a torsion spring provided with a coil and having first and second ends extending from the coil. The first end of the torsion spring is preferably mounted to the mounting plate (10) and the second end is connected to the latch plate (20), and has an angle of substantially 60° between the first and second ends when in a relaxed state. Depending on coil winding, the angle may also be substantially 240°.

In accordance with another preferred aspect of the invention, the biasing means (32) comprise a spring arm made of a heat resistant, preferably metallic material. The spring arm is substantially V-shaped, its first end being mounted to the latch plate (20), and its second end portion being mounted to the mounting plate (10). A wire coil (33) may be provided between the first end and the second end portions at the bend of the V-shape. The coil (33) in particular provides the arm with a springing ability, as in a torsion spring. The coil (33) may include multiple windings and the torsion spring may be selected with different spring force, wire thickness, coil diameter and angle by someone skilled in the art. The spring (32) is able to open the latch plate (20) only when the oven door is open. When the oven door is closed, the spring (32) is compressed. Of course, other embodiments of biasing means may also be used.

In accordance with another preferred aspect of the invention, the latch plate (20) is provided with additional biasing means (27) for further insuring the desired displacement of the latch plate (20). The additional biasing means (27) preferably comprise guide slots in the latch plate and guide projections mounted to the mounting plate (10). The guide slots are preferably disposed in the latch plate body (22), and allow projections or hooks in the mounting plate (10) to fit and slide in them, thus guiding the movement of the latch plate (20). Thus the guiding slot (24) and the additional biasing means (27) together insure that the latch plate (20) is translated along a certain predetermined path, which is substantially translational, from an unlocked to a locked position.

A motor assembly (40) is provided for moving the latch plate (20) in translation between the closed position and the locked position. The motor assembly (40) comprises a motor (42) mounted on the mounting plate (10) or otherwise fixed in relation to the mounting plate (10), controllable by the processor. The motor is advantageously a stepper motor and thus moves in small increments. A drive rotating shaft (44) is operatively connected to the motor (42) and extends through the guiding slot (24) in the latch plate (20). The drive shaft (44) can also double as the pivot axis (30).

A cam (46) is mounted on the drive shaft (44). Preferably, the cam (46) is rotationally slidable on the latch plate (20) and the translational movement of the latch plate (20) is enabled and dependant on the rotational movement of the cam (46). The latch plate (20) may be disposed of a pair of restraints (47a, 47b) between which the cam (46) sits and on which the cam (46) pushes to translationally slide the latch plate (20) in and out of the locked position. The cam (46) may also cause the translational movement of the latch plate (20) by means of a rod link as described in U.S. Pat. No. 6,315,336. The cam (46) also has an eccentric extension (48) that engages and turns the switch (12) on when the latch (20) is translated to the locked position. The eccentric extension also disengages and turns the switch (12) off when the latch plate (20) is in the closed position.

Preferably, the eccentric extension of the cam (46) engages the switch (12) when the latch plate (20) is translated from the closed to the locked position; and disengages the switch (12) when the latch plate (20) is translated back from the clocked to the closed position. However, the eccentric extension may engage and disengage the switch (12) at any point from the closed position to the locked position and back to the closed position.

In accordance with another preferred aspect of the invention, the cam (46) is mounted to the rotating shaft (44) off-centered (eccentrically). This mounting enables the cam (46) to be oriented close or far from the switch (12), depending on its degree of rotation, and thus displace the latch plate (20) in translation into the locked position. FIG. 2b shows the cam (46) and latch plate (20) close to the switch (12). FIG. 2c shows the cam (46), having rotated 180° about the shaft (44) non-centrically and thus translating the latch plate (20), further away from the switch (12). The eccentric extension (48) attached to the cam (46) is preferably a swooping curved projection as represented on FIGS. 2a to 2c and 3a to 3d.

Furthermore, as the latch plate (20) undergoes a variety of rotational and translational movements, urged by biasing means (32) and cam (46) rotation and guided by one or more guide slots, various movements (rotational and translational) of the latch plate (20) may be combined at various times. Depending on the shape and orientation of the cam, latch plate, guide slots and pivot axis, the latch plate experiences two-dimensional movement involving a combination of rotational and translational movements.

The switch (12) sends alternate signals to the processor (9) which is programmed to perform certain actions. More specifically, the processor sends an OK signal to enable a self-cleaning operation of the oven when the latch (20) is in the closed position, and the switch (12) is in the off position. The processor turns off the light when the switch (12) is in the off position. The processor also, upon receiving a signal from a self-cleaning actuator, actuates the motor (42) provided that said OK signal has been sent. The motor (42) drives the cam (46), which in turn moves the latch plate (20) into a locked position. In this locked position, the eccentric extension (48) turns on the switch (12). The processor, upon receiving the on signal from the switch (12), stops the motor (42) provided that said signal from the self-cleaning actuator has been sent and the motor (42) is in motion, and/or activates a light within the oven.

Preferably, all components are made of heat a resistant metallic material, such as steel, so that the oven heat does not inhibit operation or accelerate wear. In accordance with a first preferred embodiment of the invention, and as shown in FIGS. 2a to 2c, the switch (12) is always turned on when the latch plate (20) is in a locked position. The eccentric extension (48) of the cam (46) engages the switch (12) in the locked position, as shown is FIG. 2c. In this preferred embodiment, the processor interprets the signal sent by the switch (12) in a certain way, and via certain circuitry and/or programming.

In accordance with a second preferred embodiment of the invention, and as shown in FIGS. 3a to 3d, the switch (12) can be turned on and off when the latch plate (20) is in a locked position. The eccentric extension (48) of the cam (46) is accordingly provided with a notch (49). The notch (49) enables the switch (12) to be disengaged and turned off when the latch plate (20) is in the locked position. In other words, the notch defines two eccentric extensions. FIG. 3c shows that, when self-cleaning is preparing, the latch plate (20) has been translated to the locked position and the switch (12) is initially engaged by the eccentric extension (48). The switch (12) therefore sends a signal to the processor. The processor interprets this signal and turns off the motor (40) after a certain time so as to stop the rotation of the cam (46) in a position at which the switch (12) is disengaged. At this position, shown in FIG. 3d, the light is turned off and the self-cleaning operation goes ahead.

Advantageously, the eccentric extension has multiple projections and notches are provided thereon, for successively engaging the switch one at a time as the cam rotates. In the same vein, multiple eccentric extensions can be provided, each of which successively and individually engage the same switch. Engaging the switch (turning it to its on position) causes an additional function to be performed by the processor. Preferably, these additional functions, performed when the switch is turned to the on position, occur when an additional extension of the cam engages the switch. Alternatively, an additional function may occur when the switch is disengaged by an additional cam extension. The functions are preferably timed functions and include preheating the oven, initiating a fan, light, or indicator, waiting for an operation signal, and waiting for a confirmation signal, or any other function used in an automatic oven.

In accordance with another preferred aspect of the invention, the signal sent by the switch (12) when turned on by either the latch plate (20) or the eccentric extension (48) results in current flowing between the switch (12) and the processor, and the light turning on. The processor must be programmed accordingly.

The processor is advantageously programmed to perform various actions according to the engagement of the switch. Referring to FIGS. 3a to 3d, the switch sends alternate signals to the processor which is programmed to perform the following actions:
(i) Sending an OK signal to enable a self-cleaning operation of the oven when the latch is in the closed position, and the switch is in said off position, as in FIG. 3b. Thus, an operator is able to press an oven self-cleaning button to start the self-cleaning operation.
(ii) Turning off a light when the switch is in said off position, as in FIG. 3b. Thus when the door is closed and unlocked, the light remains off.
(iii) Upon receiving a signal from a self-cleaning actuator, actuating the motor provided that said OK signal has been sent. Referring to FIGS. 3b and 3c, the motor has rotated the cam substantially 180° and the latch plate has been translated away from the switch. Receiving the signal from the self-cleaning actuator, the motor moved the latch plate into the position as in FIG. 3c.
(iv) Upon receiving said on signal from the switch, as in FIG. 3a or 3c, one of the following actions:
   a) Stopping the motor provided that said signal from the self-cleaning actuator has been sent and the motor is in motion. This action is preferably performed when the latch plate and cam are in the locked position, and when the oven is going to perform a self-cleaning operation.
   b) Activating an electronic component, preferably timed and preferably in conjunction with stopping the motor for a predetermined time at a position where the switch is disengaged. This action is performed when the latch plate and cam are in the position as in FIG. 3c. The electronic component may be one that prepares the self-cleaning operation by pre-heating, initiating a fan, light, indicator, timer, cooler, heater or sensor, or waiting for an operation or confirmation signal. The motor may also proceed until the switch is disengaged (FIG. 3d).
   c) Activating the light within the oven, as in FIG. 3a.

The detailed steps explained hereabove are preferred embodiments of how the processor interprets the signals from the switch, as well as those from actuators, indicators, and other common signal generators used in the art. The processor may interpret the signals it receives from such sources in a myriad of ways to perform the safe self-cleaning of the oven as well as other ancillary functions such as lighting, fanning, preheating, among others.

In accordance with yet another preferred aspect of the invention, the processor is an automaton that effectuates numerous automatic operations of the oven, and accordingly contains circuitry and programming suitable for receiving, processing and sending a variety of signals.

It another preferred embodiment of the present invention, additional switches (not shown) are provided and are engaged by one or more cam extension or the latch plate, or both alternatively.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

What is claimed is:

1. An automatic oven door locking assembly for locking an oven door, said locking assembly comprising:
a mounting plate to mount the locking assembly within the oven;
a switch with an on position and an off position mounted to the mounting plate to respectively send an on signal and an off signal to an oven processor;
a latch plate operatively mounted to the mounting plate, the latch plate having a hook engageable with an anchor point within the oven to lock the oven door; the latch plate being moveable between a first position where the hook disengages the anchor point and a second position where the hook engages the anchor point, the latch plate being also movable between said first position and a third position where a portion of the latch plate engages the switch and turns the switch to said on position;
a cam mounted to a drive shaft and rotatably driven thereby, the cam being operatively connected to the latch plate so that when the cam rotates the latch plate moves between said first and second position, the cam having at least one eccentric extension that alternately engages and disengages the switch when the cam rotates, thereby alternately turning the switch to the on and off position,
biasing means operatively connected to the latch plate to urge the movement of the latch plate from the first position to said third position when the oven door is open, the latch plate being brought back to the first position upon closing the oven door.

2. The automatic oven door locking assembly as claimed in claim 1, wherein the latch plate comprises:
a first end provided with the hook; and
a second end opposite the first end, said portion of the latch plate being located at said second end and comprising a projection that engages the switch when the latch plate is moved to the third position.

3. The automatic oven door locking assembly as claimed in claim 1, wherein the movement of the latch plate between the first and third position is a rotation of the latch plat about a pivot axis, and the movement of the latch plate between the first position and the second position is a translation of the latch plate.

4. The automatic oven door locking assembly as claimed in claim 3, wherein the latch plate comprises a guide slot with the pivot axis extending therethrough to enable the latch plate to rotate and translate relative to the pivot axis.

5. The automatic oven door locking assembly as claimed in claim 4, wherein the drive shaft extends through the guide slot to act as the pivot axis.

6. The automatic oven door locking assembly as claimed in claim 4, wherein the latch plate comprises restraints on each side of the guide slot and abutting on the cam, thereby maintaining the latch plate in operational relation to the cam.

7. The automatic oven door locking assembly as claimed in claim 4, wherein the at least one eccentric extension is oriented on the cam to engage the switch when the latch plate is translated from the first position to the second position, and the at least one eccentric extension disengages the switch when the latch plate is translated from the second position to the first position.

8. The automatic oven door locking assembly as claimed in claim 7, further comprising a motor mounted to the mounting plate and wherein the drive shaft is operatively connected to the motor.

9. The automatic oven door locking assembly as claimed claim 8, wherein the motor is a stepper motor that incrementally rotates the drive shaft.

10. The automatic oven door locking assembly as claimed in claim 8, wherein the processor is programmed to perform the following actions:
sending an OK signal to enable a self-cleaning operation of the oven when the latch plate is in the first position, and the switch is in said off position;
turning off a light when the switch is in said off position;
upon receiving a signal from a self-cleaning actuator, actuating the motor provided that said OK signal has been sent;
upon receiving said on signal from the switch, either stopping the motor provided that said signal from the self-cleaning actuator has been sent and the motor is in motion, or activating the light within the oven.

11. The automatic oven door locking assembly as claimed in claim 8, wherein the at least one eccentric extension comprises two eccentric extensions that successively engage the switch when the cam rotates.

12. The automatic oven door locking assembly as claimed in claim 11, wherein the processor is programmed to perform the following actions:
sending an OK signal to enable a self-cleaning operation of the oven when the latch plate is in the first position, and the switch is in said off position;
turning off a light when the switch is in said off position;
upon receiving a signal from a self-cleaning actuator, actuating the motor provided that said OK signal has been sent;
upon receiving said on signal from the switch, performing at least one of the following actions:
stopping the motor provided that said signal from the self-cleaning actuator has been sent and the motor is in motion,
actuating an electric component; and
activating the light within the oven.

13. The automatic oven door locking assembly as claimed in claim 3, wherein the biasing means comprise a torsion spring having a coil, and first and second ends extending from said coil, the first end being connected to the mounting plate and the second end being connected to the latch plate.

14. The automatic oven door locking assembly as claimed in claim 13, wherein the torsion spring is loaded when the latch plate is in the first position, and relaxed when the latch plate is in the third position.

15. The automatic oven door locking assembly as claimed in claim 14, wherein the first and second ends of the torsion spring forms an angle between 30° and 120° when the torsion spring is relaxed.

16. The automatic oven door locking assembly as claimed in claim 15, wherein said angle of the torsion spring is 60°.

17. The automatic oven door locking assembly as claimed in claim 1, wherein the biasing means, latch plate, mounting plate, cam and switch are made of a heat resistant material.

18. The automatic oven door locking assembly as claimed in claim 17, wherein the heat resistant material is stainless steel.
